(19) United States
(12) Patent Application Publication
(10) Pub. No.: US 2003/0112462 A1
(43) Pub. Date: Jun. 19, 2003

(54) Image forming apparatus

(75) Inventor: Norikazu Ochiai, Tagata-gun (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Toshiba Tec Kabushiki Kaisha, Tokyo (JP)

(21) Appl. No.: 10/021,935

(22) Filed: Dec. 13, 2001

(51) Int. Cl. B41J 1/00; G06F 15/00

(52) U.S. Cl. 358/1.15; 358/1.16

(57) ABSTRACT

An image forming apparatus connected to a network to which a plurality of computers are connected in order to enable communication, including a storage section which receives and stores user identification information for identifying a user of the computer together with printing information from the computer, a sheet counter section which prepares page information from the printing information, and a controller section which controls to print the user identification information and page information on a back surface of a sheet.

### BACKGROUND OF THE INVENTION

1. Field of the Invention

The present invention relates to image forming apparatuses such as a printer which is used as a network printer by a plurality of people in an office, and the like, and a multifunctional printer.

2. Description of the Related Art

A computer used by each user and an image forming apparatus in an office, and the like are connected to a network. In the image forming apparatus connected to the network in this manner, when printing commands are received from a plurality of users substantially at the same time, an interrupt printing is performed in some cases. A sorter is disposed to prevent identification of a printed sheet discharged after the interrupt printing from being inhibited, so that positions for discharging the printed sheets of respective users are classified and the printed sheets are distinguished. However, when the sorter is attached to the image forming apparatus, the apparatus is enlarged, and the sorter takes up a large installation space.

In the image forming apparatus disclosed in Jpn. Pat. Appln. KOKAI Publication No. 2001-113801, when a sheet facing downwards is discharged, the printed sheet is distinguished by information and a tag for identifying the user printed on the right side of an upper surface of the sheet. Moreover, the image forming apparatus disclosed in Jpn. Pat. Appln. KOKAI Publication No. 2001-88407 includes means for storing user identification information for identifying the user and setting printing specifications in accordance with information which specifies the user identification information designated by the user with the computer and printing information. In the image forming apparatus, the user identification information is read from a storage based on the set printing specifications, and the user identification information is printed on the upper surface of the sheet of a discharge time so that the user can distinguish the printed sheet.

In the image forming apparatus, the user identification information is printed on the upper surface of the sheet at the discharge time so that the printed sheet is distinguished. However, the upper surface does not have a page number printed thereon. Therefore, when interrupt printing is performed, the user cannot see the page number of the sheet being printed at a glance. Moreover, a page number at which the printed sheet is interrupted, and the number of sheets yet to be printed are not known. Furthermore, a plurality of printed sheets subjected to the interrupt printing are accumulated in a sheet receiver of the image forming apparatus, and the user may try to take them out. In this case, even when the user identification information is printed, it is impossible to see the page number at which the interrupt occurs at a glance. That is, the number of another user's printed sheets inserted in the user's own printed sheets is not known, thus the user cannot easily take out the user's printed sheets in some cases.

Moreover, another image forming apparatus is known in which the user identification information and the number of printed sheets are printed on a header or a footer of a printed surface of the sheet in order to distinguish the printed sheets. When the user identification information and page information are printed on the header or the footer of the printed surface, and when the printed sheet with the printed surface facing downwards is discharged, each printed sheet accumulated in the sheet receiver has to be turned over and distinguished, and much time is required.

### BRIEF SUMMARY OF THE INVENTION

An object of the present invention is to provide an image forming apparatus and a method of operating the image forming apparatus for forming an image which enable easy recognition of a user's printed sheets.

According to an aspect of the present invention, there is provided an image forming apparatus connected to a network to which a plurality of computers are connected in order to enable communication. The image forming apparatus includes: a storage section which receives and stores user identification information for identifying a user of the computer together with printing information from the computer; a sheet counter section which prepares page information from the printing information; and a controller section which controls to print the user identification information and the page information on a back surface of a sheet.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and comprise a part of the specification, illustrate presently embodiments of the invention, and together with the general description given above and the detailed description of the embodiments given below, serve to explain the principles of the invention.

FIG. 1 is a diagram showing a network structure in one embodiment of the present invention.

FIG. 2 is a perspective view showing an appearance of a printer in the embodiment.

FIG. 3 is an explanatory view schematically showing a mechanism of the printer for printing information on both sides of a sheet in the embodiment.

FIG. 4 is a control block diagram of the printer in the embodiment.

FIG. 5 is a chart showing a flow of a processing executed by a control/drive circuit section in the embodiment.

FIG. 6 is a diagram showing the sheet with page information and user identification information printed thereon which is accumulated in a sheet receiver of the printer in the embodiment.

FIG. 7 is a control block diagram of the printer in another embodiment.

### DETAILED DESCRIPTION OF THE INVENTION

Embodiments of the present invention will be described hereinafter with reference to the drawings.

(First Embodiment)

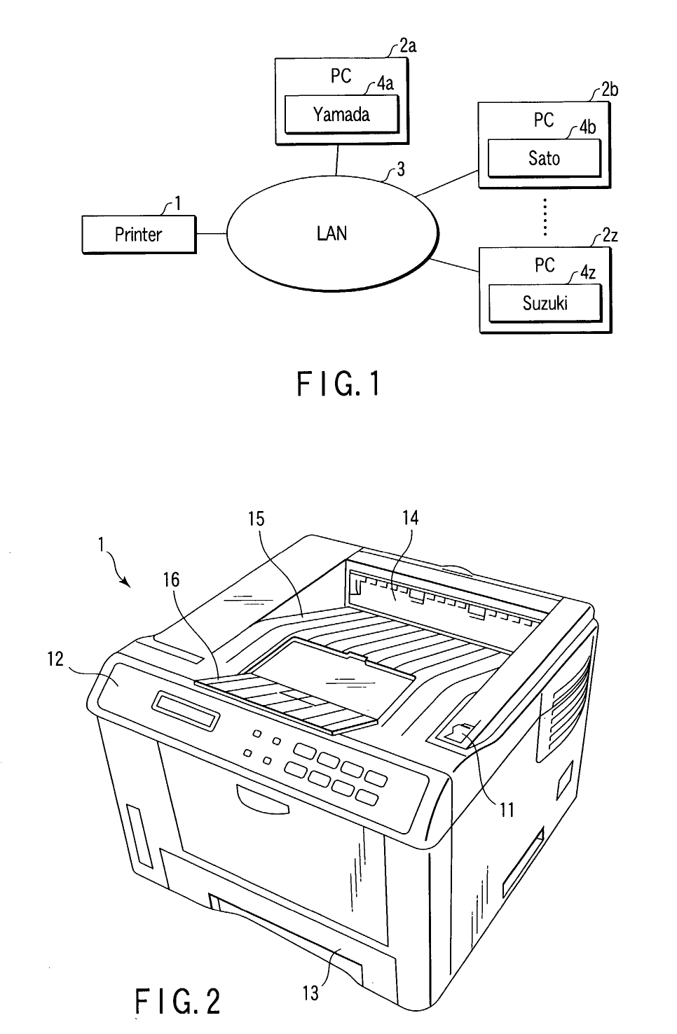

FIG. 1 is a diagram showing a network structure in one embodiment of the present invention. Reference numeral 1 denotes a printer as an image forming apparatus, and numerals 2a, 2b, . . . , 2z denote PCs(personal computers). The image forming apparatus 1 and a plurality of PC 2a, 2b, . . . , 2z are connected to a LAN(local area network) 3 so as to enable communications.

Each PC 2a, 2b, . . . , or 2z stores user identification information for identifying each user. As information for identifying the user, for example, the PC 2a stores “Yamada” 4a, the PC 2b stores “Sato” 4b, . . . , and the PC 2z stores “Suzuki” 4z. Each user's name is stored and set in this manner.

When each user uses each PC to transmit printing information to the printer 1, each user can operate each PC to set whether or not the user identification information and page information are to be printed. The set information is transmitted as setting information to the printer 1 together with printing information for performing the printing. Here, the page information is prepared based on the printing information. For example, when X denotes the total pages number as the number of printed sheets, and Y denotes a page number of each sheet, the page information is information Y/X indicating a relation between the total pages number and the page number.

FIG. 2 is a perspective view showing an appearance of the printer 1 in the embodiment. The printer 1 includes: a power switch 11 for turning on a power; an operator 12 for performing various settings; a sheet cassette 13 for setting sheets P; a sheet discharge port 14 for discharging the printed sheets P; and an auxiliary plate 16 for allowing the sheets P discharged through the sheet discharge port 14 to be accumulated in a sheet receiver 15.

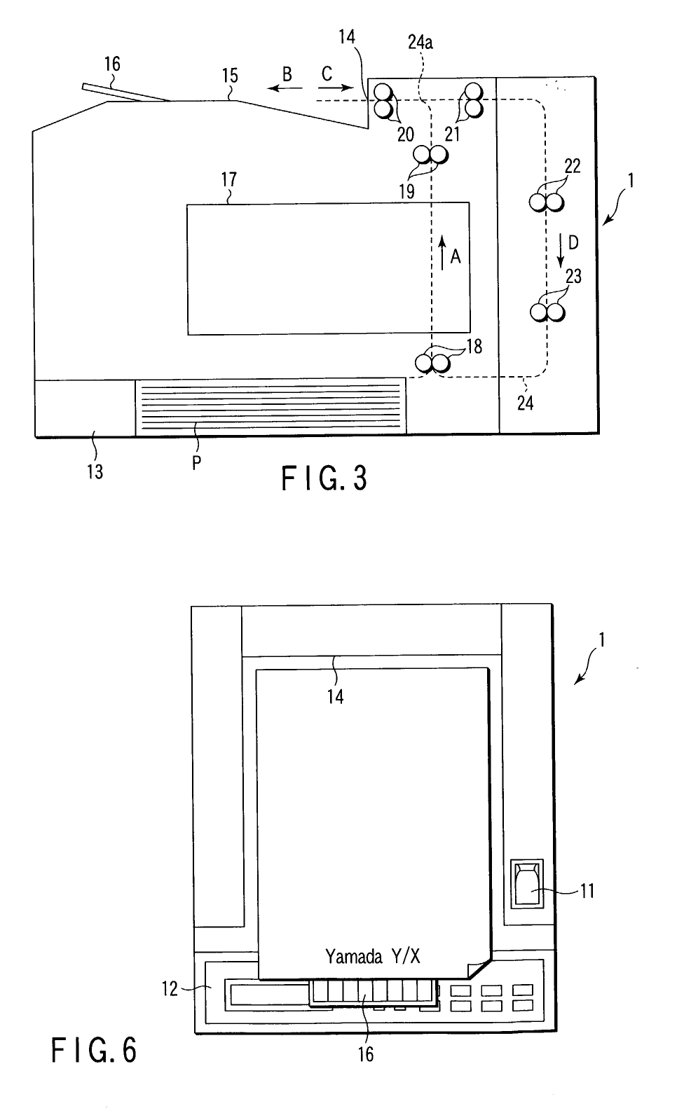

FIG. 3 is an explanatory view schematically showing a mechanism of the printer 1 for printing information on both sides of the sheet P. A reference numeral 17 denotes a printing section for forming and printing an image on the sheet P by a photosensitive member, exposure device, developing device, transfer device, fixing device, cleaning device, and the like (not shown). Numerals 18, 19, 20, 21, 22, 23 show pairs of conveyance rollers for use in conveying the sheet P. Additionally, the conveyance rollers 20 rotate forwards and backwards. Moreover, a broken line 24 in FIG. 3 shows a conveyance path of the sheet P, when the both sides of the sheet P are printed.

The sheet P fed from the sheet cassette 13 is passed through the printing section 17 by the conveyance rollers 18 as shown by an arrow A in FIG. 3 and one surface of the sheet P is printed. Moreover, the sheet P is conveyed by the conveyance rollers 19, 20 as shown by an arrow B in FIG. 3. The sheet P is discharged from the sheet discharge port 14 until a back end of the sheet P passes a discharge direction side than point 24a, during that time the sheet P is held by the conveyance roller 20. Subsequently, the conveyance rollers 20 rotate backward, and convey the sheet P into the printer 1 as shown by an arrow C in FIG. 3. In this case, for example, a conveyance path changing switch (not shown) disposed in the vicinity of the turning point 24a is operated, and the sheet P is conveyed into the conveyance rollers 21. Subsequently, as shown by an arrow D in FIG. 3, the sheet P is conveyed into the conveyance rollers 18 by the conveyance rollers 22, 23. Moreover, the sheet P is passed again through the printing section 17 by the conveyance rollers 18. In this case, when the sheet P is passed through the printing section 17, the sheet is reversed, and the information is printed on a non-printed surface of the sheet. When the both sides of the sheet P are printed in this manner, the changing switch is operated in order to discharge the sheet to the sheet receiver 15 from the sheet discharge port 14 by the conveyance rollers 19, 20. The printer 1 has a mechanism for printing the both sides of the sheet in this manner.

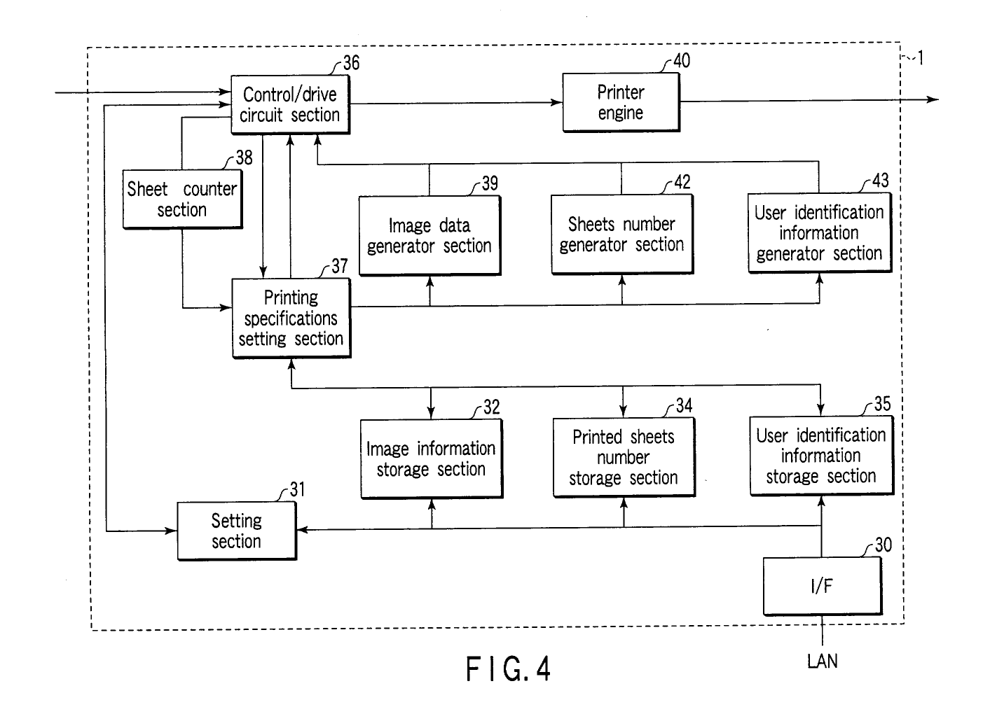

FIG. 4 is a control block diagram of the printer 1.

The printer 1 receives the set information, printing information, and user identification information from the PC via an interface (I/F) 30. The received setting information is stored in a setting section 31. Image information for forming a printed image, and printed sheets number information indicating the number of sheets to be printed are acquired from the received printing information. The acquired image information is stored in an image information storage section 32, and the acquired printed sheets number information is stored in a printed sheets number storage section 34. The received user identification information is stored in a user identification information storage section 35. The information is stored into the image information storage section 32, printed sheets number storage section 34, and user identification information storage section 35 by control of a control/drive circuit section 36 as a controller.

The control/drive circuit section 36 controls a printing specifications setting section 37 to set printing specifications so that the specifications are temporarily stored in a memory disposed in the printing specifications setting section 37. Moreover, the control/drive circuit section 36 controls a sheet counter section 38, prepares the page information Y/X (Y denotes the page number and X denotes the total pages number) from the information stored in the printed sheets number storage section 34, and sends the information to the printing specifications setting section 37. Here, for the page information Y/X, X has the same value as the value of the number of sheets to be printed, and Y is increased by one for each printed sheet in printing order. The page information is printed in a position, described below, of the back surface of the sheet P. The page information is temporarily stored in the memory disposed in the printing specifications setting section 37.

Here, the back surface of the sheet P faces upwards when the sheet P is discharged to the sheet receiver 15. On the other hand, a front surface of the sheet faces downwards when the sheet P is discharged to the sheet receiver 15.

An image data generator section 39, controlled by the printing specifications setting section 37, generates image data for driving a printer engine 40 and temporarily stores the data in a memory disposed therein. A sheets number generator section 42, controlled by the printing specifications setting section 37, generates page information data for driving the printer engine 40 and temporarily stores the data in a memory disposed therein. A user identification information generator section 43, controlled by the printing specifications setting section 37, generates user identification information data for driving the printer engine 40 and temporarily stores the data in a memory disposed therein.

The control/drive circuit section 36 controls the printer engine 40 based on the image data, page information data, and user identification information data stored in the image data generator section 39, sheets number generator section 41, and user identification information generator section 43, and the printing specifications temporarily stored in the memory of the printing specifications setting section 37. Thereby, the printer 1 prints the image information, user identification information, and page information onto the sheet P.

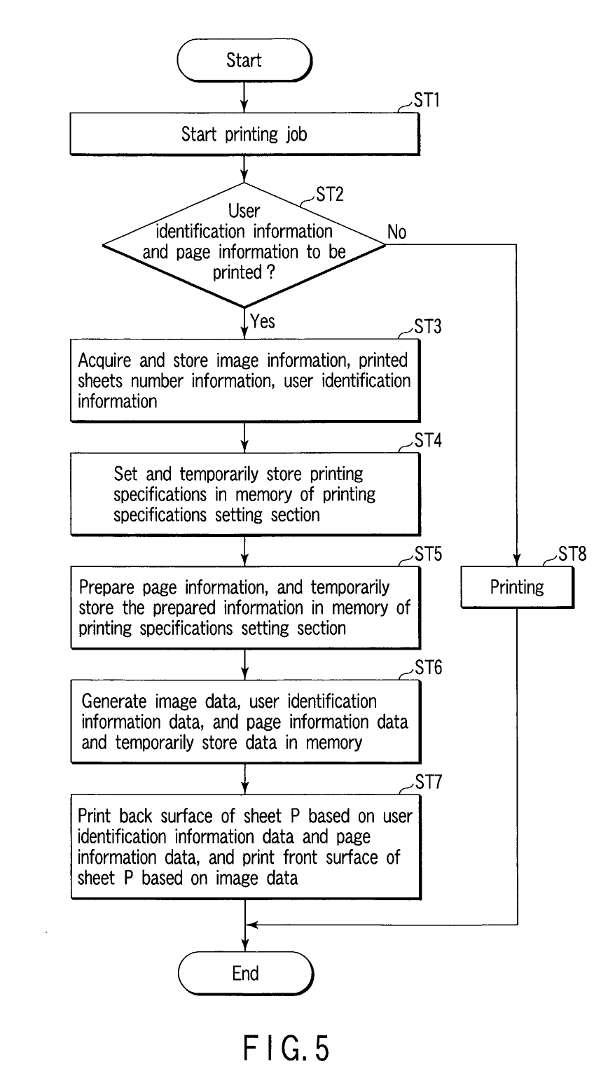

FIG. 5 is a flowchart showing a flow of a processing executed by the control/drive circuit section 36 in the embodiment, when the image information is printed on one surface of the sheet P facing downwards. Upon receiving the set information, printing information, and user identification information from either PC connected to the LAN 3, the control/drive circuit section 36 starts this processing.

In step ST1, the control/drive circuit section 36 starts a printing job. In step ST2, it is judged from the set information stored in the setting section 31 whether or not the printer is set so as to print the page information and user identification information.

It is judged that the printer is set to print the page information and user identification information. Subsequently, in step ST3, the image information, printed sheets number information, and user identification information are acquired and temporarily stored in the image information storage section 32, printed sheets number storage section 34, and user identification information storage section 35, respectively.

Next, in step ST4, the printing specifications setting section 37 is controlled based on the information stored in each storage, and the printing specifications are set and temporarily stored in the memory disposed in the printing specifications setting section 37. In step ST5, the sheet counter section 38 is controlled, and the page information is prepared and temporarily stored in the memory in the printing specifications setting section 37.

Subsequently, in step ST6, various data for operating the printer engine 40 is generated and temporarily stored in the memory. That is, the image data is generated by the image data generator section 39 and temporarily stored in the memory. The page information data is generated by the sheets number generator section 42 and temporarily stored in the memory. The user identification information data is generated by the user identification information generator section 43 and temporarily stored in the memory.

Next in step ST7, the back surface of the sheet P is printed based on the user identification information data and page information data, the front surface of the sheet P is printed based on the image data, and the processing is ended.

On the other hand, it is judged in the step ST2 that the printer is set not to print the user identification information and page number. In this case, the processing of the steps ST3 to ST7 is not performed, and the sheet is printed only based on the printing information in step ST8. Subsequently, this processing is ended.

Additionally, in step ST7, the processing for printing the image information on the both sides of the sheet P by the control/drive circuit section 36 includes: printing the back surface of the sheet P based on the image data as well as the user identification information data and page information data; and printing the front surface of the sheet P based on the image data.

FIG. 6 is a diagram showing the sheet P on which the set information for printing the page information and user identification information, the user identification information, and the printing information for printing one surface of the sheet P facing downwards received from the PC 2a are printed, and which is discharged to the sheet receiver 15 of the printer 1.

The surface of the sheet P with predetermined image information printed thereon faces downwards, and the back surface thereof with the user identification information “Yamada” and page information “Y/X” printed thereon faces upwards so that the user can recognize this information at a glance, during discharging of the sheet P to the sheet receiver 15. Moreover, a position with “Yamada Y/X” to be printed thereon is set such that the information is printed on an edge of the sheet P opposite to the sheet discharge port 14.

Two other cases will next be described: in one case the image information is printed on one surface of the sheet P facing downwards, when the printing information for 15 pages and the printing information for 10 pages are transmitted to the printer 1 from the PC 2a and PC 2b, respectively; and in the other case the image information is printed on the both sides of the sheet P. In both cases, the user identification information and page information are set to be printed. When the printing information for eight pages from the PC 2a is printed, interrupt printing of the printing information from PC 2b is performed.

The printing of one surface of the sheet P facing downwards will be described. In this case, 25 sheets P are accumulated in the sheet receiver 15 of the printer 1. For the accumulated sheets P, “Yamada 1/15” is printed on the back surface of the lowermost sheet P, and the sheets P with “Yamada 2/15”, . . . , “Yamada 8/15” printed on the back surfaces thereof are accumulated on the lowermost sheet. Moreover, “Sato 1/10” is printed on the back surface of the upper sheet P, and the sheets P with “Sato 2/10”, . . . , “Sato 10/10” printed on the back surfaces thereof are further accumulated. Furthermore, the sheets P with “Yamada 9/15”, . . . , “Yamada 15/15” printed on the back surfaces thereof are accumulated.

Therefore, when the user of the PC 2a takes out the sheets P from the sheet receiver 15, the user can identify the user's own printed sheets from “Yamada 15/15” printed on the uppermost sheet P without checking the surface of the sheet with the image data printed thereon. The user can also confirm that the number of printed sheets is 15 pages.

Moreover, the user's printed sheets are interrupted by the printed sheets of the user of the PC 2b, and it is easily known from “Yamada 9/15” printed on the sheet P before the interruption that there remain six printed sheets.

Furthermore, “Sato 10/10” printed on the sheet P under the sheet P with “Yamada 9/15” printed thereon is visually recognized and it is known that ten pages are another user's printed sheets, so that the user's interrupted printed sheets can easily be found.

The printing of the image information on the both sides of the sheet P will next be described. In this case, eight pages of the printing information for 15 pages, and five pages of the printing information for ten pages are printed, and 13 sheets are accumulated in the sheet receiver 15 of the printer 1. For the lowermost accumulated sheet P, “Yamada ⅛” is printed on the back surface of the sheet P, and the sheets P with “Yamada 2/8”, . . . , “Yamada 4/8” printed on the back surfaces thereof are superposed. Moreover, the sheets P with “Sato ⅕”, “Sato ⅖”, . . . , “Sato 5/5” printed on the back surfaces thereof are superposed. Furthermore, the sheets P with “Yamada ⅝”, “Yamada 8/8” printed on the back surfaces thereof are superposed.

Therefore, when the user of the PC 2a takes out the sheets P accumulated in the sheet receiver 15, similarly as the one-surface printing, the user's own printed sheets can be identified. It can also be confirmed that the total number of printed sheets is eight sheets. Moreover, it is confirmed from “Yamada ⅝” printed on the sheet P before the interruption that there remain four sheets. It is also confirmed from “Sato 5/5” printed on the sheet P that five sheets including the sheet are another user's printed sheets, and the user's interrupted printed sheets can easily be found.

According to the first embodiment, the user sees at a glance the page numbers of the user's sheets printed by the printer 1. Moreover, at the end of the printing, even when the another user's printed sheets are inserted in the user's own printed sheets, the user can easily distinguish and pick up the user's own printed sheets from a bundle of printed sheets accumulated in the sheet receiver 15.

Moreover, when the user picks up the printed sheets from the sheet receiver 15, the user usually holds the edge of the sheet P opposite to the sheet discharge port 14. Since the user identification information and page information are printed in a position near the user's hand, the user easily turn over the sheet P and can check the user can identification information and page information.

Furthermore, with an important document for which excessive printing is not desired, the user can select a setting that the user identification information and page information are not printed.

Additionally, the page information Y/X is prepared such that the page number Y is increased by one in a printing order, but may be prepared such that the page number is decreased by one from the last page number. Thereby, the page number increases in order from the upper accumulated sheet P. Therefore, when the user's own printed sheets are interrupted by the another user's printed sheets, the user can more easily distinguish the remaining printed sheets.

Moreover, for the printed position of the user identification information and page information, the information is printed on the edge of the sheet P opposite to the sheet discharge port 14, but this is not limited, and the position can freely be set. With the free setting, the user identification information and page information can be printed in a position such that the sheet P is easily picked up in accordance with an installation position of the printer 1 in an office and as desired by the user.

Furthermore, the user identification information is the name of the user who uses each PC, but this is not limited, and the user identification information may be a name or a mark set by the user, or a combination of the name and mark.

(Second Embodiment)

A second embodiment will next be described. Additionally, the same components as those of the first embodiment are denoted with the same reference numerals and detailed description thereof is omitted.

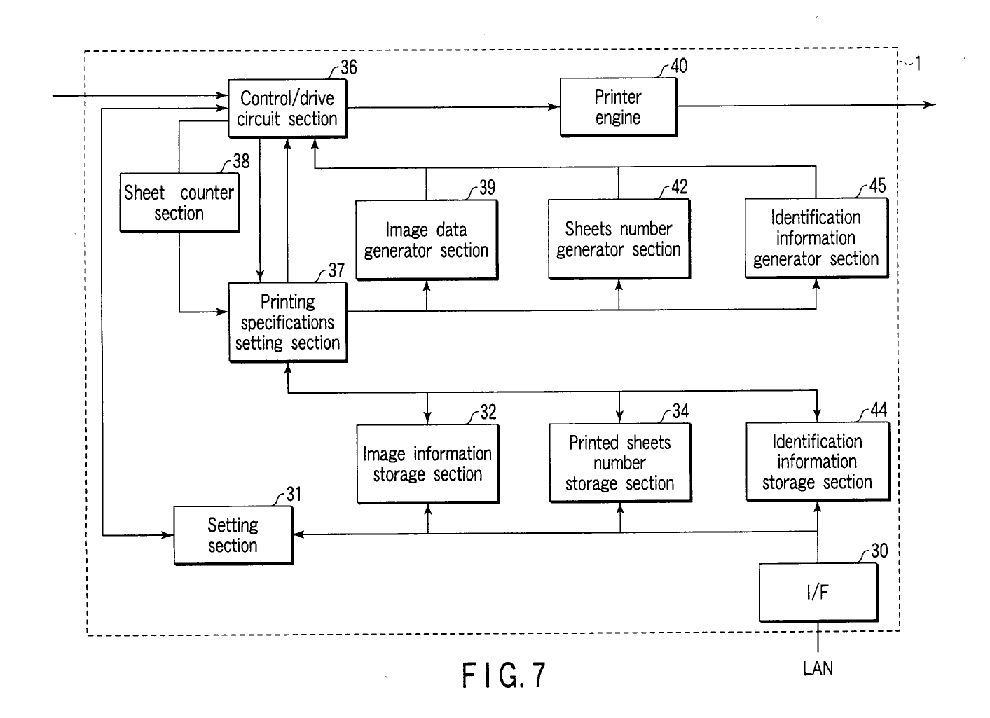

A construct different from that of the first embodiment will be described with reference to FIG. 7 as a control block diagram of the printer 1 in the second embodiment. As shown in FIG. 7, an identification information storage section 44 replaces the user identification information storage section 35, and an identification information generator section 45 replaces the user identification information generator section 43. The identification information is stored in the identification information storage section 44 so that identification information data such as “AAA”, “BBB”, . . . , “ZZZ” are prepared for the respective identification information by the identification information generator section 45. The information is stored not to be exhausted in the identification information storage section 44 in accordance with the number of PCs connected to the LAN 3 and printing amount for one day.

The printer 1 constructed as described above receives the printing information together with the set information from the respective PCs 2a, 2b, . . . , 2z, and it is judged from the set information that the identification information and page information are to be printed. Then, the control/drive circuit section 36 applies the identification information for each printing information from the identification information storage section 44 in order so that the identification information is not redundant. Moreover, the printer 1 generates the identification information data for controlling the printer engine 40 and prints the data together with the page information data. During the printing, for example, “AAA Y/X” is printed on the back surface of the sheet P.

According to the second embodiment, when the printing is already ended, and even when the another user's printed sheets are inserted in the printed sheets, the user can easily distinguish the printed sheets. Because the identification information and page information different with the respective printed sheets are printed.

Moreover, according to the printer 1 of the second embodiment, even when the PC with the user identification information not set therein is temporarily connected to the LAN, and the information from the PC is printed, the page information and identification information are easily printed on the sheet P and the printed sheets can conveniently be distinguished.

Additionally, the identification information to be printed together with the page information is set such that the printer 1 automatically prints the information and the information is not redundantly printed. Alternatively, the user can designate the identification information by the PC, and the information may be printed based on the designation so that the information is not redundant. Thereby, the user can easily identify the user's printed sheets.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus connected to a network to which a plurality of computers are connected in order to enable communication, comprising:
a storage section which receives and stores user identification information for identifying a user of a computer together with printing information from said computer;
a sheet counter section which prepares page information from said printing information; and
a controller section which controls to print said user identification information and the page information on a back surface of a sheet.

2. The image forming apparatus according to claim 1, further comprising:
a setting section which stores setting information for setting whether or not to print said page information and said user identification information received from said network,
wherein the controller section judges whether or not the page information and the user identification information are to be printed on the back surface of the sheet based on the setting information stored in said setting section.

3. The image forming apparatus according to claim 1, wherein said sheet counter section uses the number of printed sheets as a total pages number and prepares the page information, when the printing information is printed on both sides of the sheet.

4. The image forming apparatus according to claim 1, wherein said page information is prepared by addition in order of the discharged sheets.

5. The image forming apparatus according to claim 1, wherein said page information is prepared by subtraction from the total pages number in order of the discharged sheets.

6. The image forming apparatus according to claim 1, wherein said controller section prints the page information and the user identification information on an edge of the sheet opposite to a sheet discharge port from which the sheet is discharged.

7. An image forming apparatus connected to a network to which a plurality of computers are connected in order to enable communication, comprising:
a storage section which receives and stores printing information from the computer;
a sheet counter section which prepares page information from said printing information;
an identification information storage section which stores identification information applied to said each stored printing information; and
a controller section which controls to print the identification information applied to said printing information together with said page information on a back surface of a sheet.

8. The image forming apparatus according to claim 7, further comprising:
a setting section which stores setting information for setting whether or not to print said page information received from said network,
wherein the controller section judges whether or not the page information and said identification information are to be printed on the back surface of the sheet based on the setting information stored in said setting section.

9. The image forming apparatus according to claim 7, wherein said sheet counter section uses the number of printed sheets as a total pages number and prepares the page information, when the printing information is printed on both sides of the sheet.

10. The image forming apparatus according to claim 7, wherein said page information is prepared by addition in order of the discharged sheets.

11. The image forming apparatus according to claim 7, wherein said page information is prepared by subtraction from the total pages number in order of the discharged sheets.

12. The image forming apparatus according to claim 7, wherein said controller section prints the page information and the identification information on an edge of the sheet opposite to a sheet discharge port from which the sheet is discharged.

13. A method of operating an image forming apparatus connected to a network to which a plurality of computers are connected in order to enable communication, comprising:
receiving and storing user identification information for identifying a user of the computer together with printing information from the computer;
preparing page information from said printing information by a sheet counter section; and
printing said user identification information and said page information on a back surface of a sheet.

14. The method of operating the image forming apparatus according to claim 13, further comprising a judging whether or not said page information and the user identification information are to be printed based on information of a setting section which stores setting information for setting whether or not to print said page information and said user identification information received from said network.

15. The method of operating the image forming apparatus according to claim 13, wherein said sheet counter section uses the number of printed sheets as a total pages number and prepares the page information, when the printing information is printed on both sides of the sheet.

16. The method of operating the image forming apparatus according to claim 13, wherein said page information is prepared by addition in order of the discharged sheets.

17. The method of operating the image forming apparatus according to claim 13, wherein said page information is prepared by subtraction from the total pages number in order of the discharged sheets.

18. The method of operating the image forming apparatus according to claim 13, wherein a printing the page information and the user identification information on an edge of the sheet opposite to a sheet discharge port from which the sheet is discharged.

19. A method of operating an image forming apparatus connected to a network to which a plurality of computers are connected in order to enable communication, comprising:
receiving and storing printing information from the computer;
preparing page information from said printing information by a sheet counter section;
applying identification information to said each stored printing information from an identification information storage section which stores the identification information; and
printing the identification information applied to said each printing information together with said page information on a back surface of a sheet.

20. The method of operating the image forming apparatus according to claim 19, further comprising a judging whether or not said page information and said identification information are to be printed based on information of a setting section which stores setting information for setting whether or not to print said page information and said identification information received from said network.

21. The method of operating the image forming apparatus according to claim 19, wherein said sheet counter section uses the number of printed sheets as a total pages number and prepares the page information, when the printing information is printed on both sides of the sheet.

22. The method of operating the image forming apparatus according to claim 19, wherein said page information is prepared by addition in order of the discharged sheets.

23. The method of operating the image forming apparatus according to claim 19, wherein said page information is prepared by subtraction from the total pages number in order of the discharged sheets.

24. The method of operating the image forming apparatus according to claim 19, wherein a printing the page information and the identification information on an edge of the sheet opposite to a sheet discharge port from which the sheet is discharged.
